(19) United States
(12) Patent Application Publication
(10) Pub. No.: US 2006/0292430 A1
(43) Pub. Date: Dec. 28, 2006

(54) Fuel cell and fuel cell module therefor

(76) Inventors: Helmut Lessing, Sarstedt (DE); Gunter Borchardt, Clausthal-Zellerfeld (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 10/571,612

(22) PCT Filed: Sep. 9, 2004
(86) PCT No.: PCT/DE04/02021

§ 371 Date: Mar. 10, 2006

(30) Foreign Application Priority Data
Sep. 12, 2003 (DE) 10342493.8

(51) Int. Cl. H01M 8/24; H01M 4/86

(52) U.S. Cl. 429/38; 429/44

(57) ABSTRACT

A fuel cell module includes a multitude of permeable anode plates and cathode plates which are stacked one above the other in an alternating manner. An electrolyte material is positioned between adjacent anode plates and cathode plates. Connections to the anode plates and cathode plates are provided for carrying away gas and fuel. Both the anode plates and the cathode plates are connected in parallel.

The invention relates to a fuel cell module having a large number of permeable anode and cathode plates which are stacked one on top of the other, having electrolyte material between adjacent anode and cathode plates, and having connections to the anode and cathode plates for supplying and carrying away gas and fuel, with the anode plates being connected electrically in parallel and the cathode plates being connected electrically in parallel.

The invention also relates to a fuel cell which is formed from at least two such fuel cell modules.

Fuel cells for the generation of electrical energy by means of an electrochemical reaction between fuel and gas are sufficiently known and are used, for example, for supplying buildings or vehicles. In the case of the so-called “Solid Oxide Fuel Cells” SOFC, a cell in a fuel cell module is formed from a permeable anode plate, an impermeable electrolyte intermediate layer and a permeable cathode plate stacked one on top of the other. Oxygen is passed through the cathode plate and fuel, for example H₂+CO, is passed through the anode plate. During this process, negatively charged oxygen ions migrate from the cathode plate through the ion-conducting electrolyte intermediate layer and react with the hydrogen in the anode plate, with water being formed (2H₂+2O⁼=>4e⁻+2H₂O). Four electrodes are absorbed by the cathode plate, corresponding to the four electrodes which are emitted at the electrical connection of the anode plate (O₂+4e⁻=>2O⁼). The water reacts with the methane gas, with hydrogen and carbon dioxide being formed (CO+H₂O=>H₂+CO₂). Water and carbon dioxide as well as heat are emitted (H₂O+CO₂) at the outlet of the anode plates.

Conventionally, the individual cells in the fuel cell modules as well as the fuel cell modules in a fuel cell are connected in series in order to increase the output voltage.

Problems with gas leaks and with the electrical power being reduced by degradation occur in the stacks that are required with above 30 or more cell layers and with the high temperatures and temperature fluctuations that occur. Furthermore, temperature control of about 850 to 950° C. is problematic. In addition, temperature fluctuations in the various metal and ceramic layers can lead to stress cracking.

EP 0 947 019 B1 and DE 40 11 506 A1 describe a fuel cell in which gas and fuel are supplied through an overall plate stack.

WO 01/29923 A1 describes individual fuel cells which can be connected to tube connections for supplying and carrying away gas. Independently of these, electrical connections are provided on the end faces.

U.S. Pat. No. 5,069,985 describes a fuel cell module which is stacked in a cruciform shape, is connected in series and has a common gas supply, gas outlet, fuel supply and fuel outlet on each end face. The fuel cells are electrically connected in series, so that the supply and outlet connections are connected to the end faces in an electrically insulated form.

A fuel cell stack having anode and cathode plates which are in each case electrically connected in parallel is described in US 2003/0044657 A1. The parallel connection results in water vapor not being vaporized in the body, as when connected in series. The gas and fuel are supplied and carried away at the upper face and lower face of the fuel cell stack. In this case, gas and fuel are disadvantageously passed through the entire stack, which can lead to different gas and fuel distributions.

One object of the invention is thus to provide an improved fuel cell module having a large number of permeable anode and cathode plates which are stacked one on top of the other, having electrolyte material between adjacent anode and cathode plates, and having connections to the anode and cathode plates for supplying and carrying away gas and fuel, and to a fuel cell which is formed from at least two such fuel cell modules.

The object is achieved according to the invention by the fuel cell module of this generic type, in that the anode plates and cathode plates each have parallel tubes which extend in the longitudinal direction for gas or fuel to pass through. The longitudinal axes of the anode plates are aligned offset at an angle to the longitudinal axes of the cathode plates, and metallic connecting stubs are arranged on the end faces of the anode plates and cathode plates. The tubes open at the end faces of the anode and cathode plates and can communicate there by means of the metallic connecting stubs with supply or outlet connections for gas or fuel. Those connecting stubs which are in each case located on a common end face are in this case connected electrically in parallel to the connecting stubs, and are connected to a common supply line or outlet line.

In contrast to conventional fuel cell modules with cells connected in series, as are known from US 2003/0044657 A1, the cells are connected in parallel. Initially, this admittedly has the disadvantage that the voltage of the fuel cell module is less than in the case of conventional series connection. However, the advantage associated with parallel connection in conjunction with the arrangement which is known per se from U.S. Pat. No. 5,069,985 is that both the gas and fuel supply and outlet as well as the electrical connection to the respective end faces of the anode and cathode plates can now each be combined.

Stacking a plurality of anode and cathode plates one on top of the other doubles the functional areas in comparison to single-cell modules, since the upper face and lower face of the anode and cathode plates are used for the electrochemical coupling.

The anode and cathode plates preferably have a rectangular base area with longitudinal faces which are longer than the end faces, with the anode plates being aligned parallel to one another and the cathode plates being aligned parallel to one another. The anode and cathode plates are arranged centered and the longitudinal axes of the anode plates are aligned offset at an angle to the longitudinal axes of the cathode plates. A single supply line or outlet line for gas or fuel can thus be arranged on each side face of the fuel cell module.

It is particularly advantageous for the separate arrangement of the supply and outlet connections for the anode and cathode plates to be arranged centered in a cruciform shape, with the longitudinal axes of the anode plates being aligned at right angles to the longitudinal axes of the cathode plates.

It is advantageous if electrically conductive filling material is introduced at the end faces into the spaces between those connecting ends of the anode or cathode plates which are located one on top of the other, and completely fills the spaces. The common supply line or outlet line may then have a connecting stub which extends over the height of the fuel cell module and over the width of the associated end face, so that the anode and cathode plates can be connected in a reliably gas-tight manner despite possible temperature fluctuations.

It is also advantageous if the anode plates and the cathode plates have an electrically insulating, ion-conducting electrolyte layer on the surfaces of the rectangular base area. The electrolyte layer may, for example, have 8YSR or ScSZ, as is adequately known from fuel cell technology.

Furthermore, an electrically insulating, ion-conducting intermediate layer is in each case arranged between anode plates and cathode plates which are arranged one on top of the other. This increases the permeability for ions and provides a “weak point” in the thermal gradient. The intermediate layer may, for example, have nickel-8YSR or CeOₓ/Ni, for example, as known from fuel cell technology.

The anode plates may be formed in a known manner from cermet material, in particular nickel cermet, and the cathode plates may be formed from ceramic material, in particular perovskite (LSM or LaₓSr_{y}Ca_{z}MnO₃), by burning after the forming of plate blanks provided with parallel tubes.

The problem of the relatively low voltage of the fuel cell modules can be solved by a power electronics circuit having a current/voltage converter for increasing the voltage.

The object is also achieved by a fuel cell battery, by electrically connecting at least two fuel cell modules of the type described above in series. In this case, the fuel cell modules are preferably stacked one on top of the other.

The invention will be explained in more detail in the following text with reference, by way of example, to the attached drawings, in which:

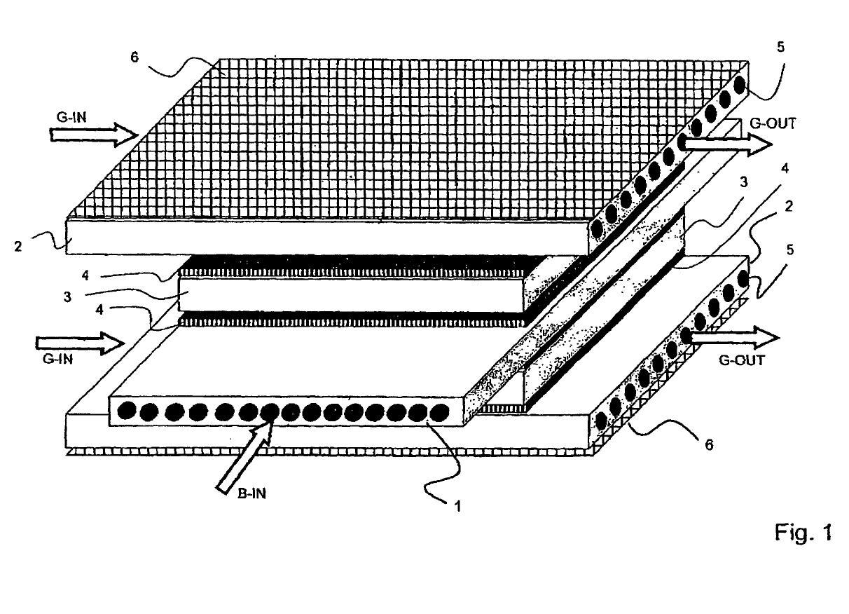

FIG. 1 shows a perspective view of the layer structure of an individual cell comprising an anode plate, cathode plate, electrolyte material and intermediate layers;

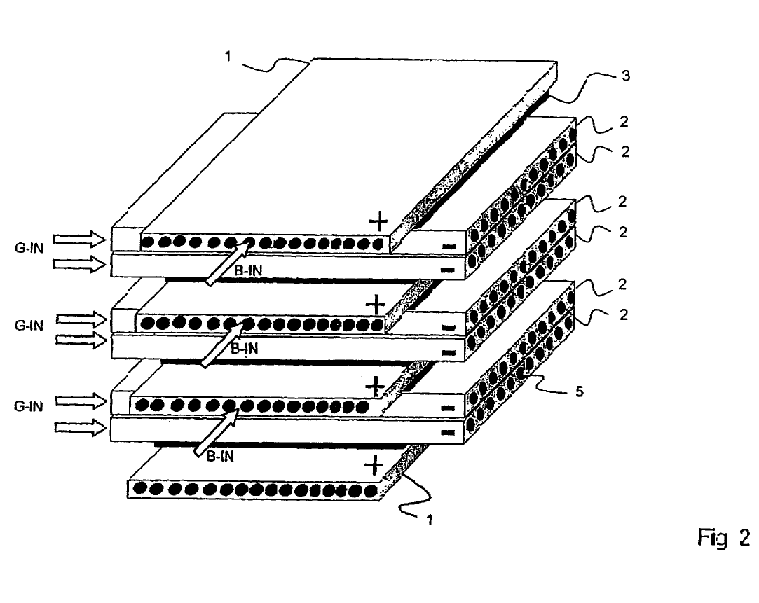

FIG. 2 shows a perspective view of a fuel cell module having a large number of individual cells which are stacked one on top of the other alternately in a cruciform manner;

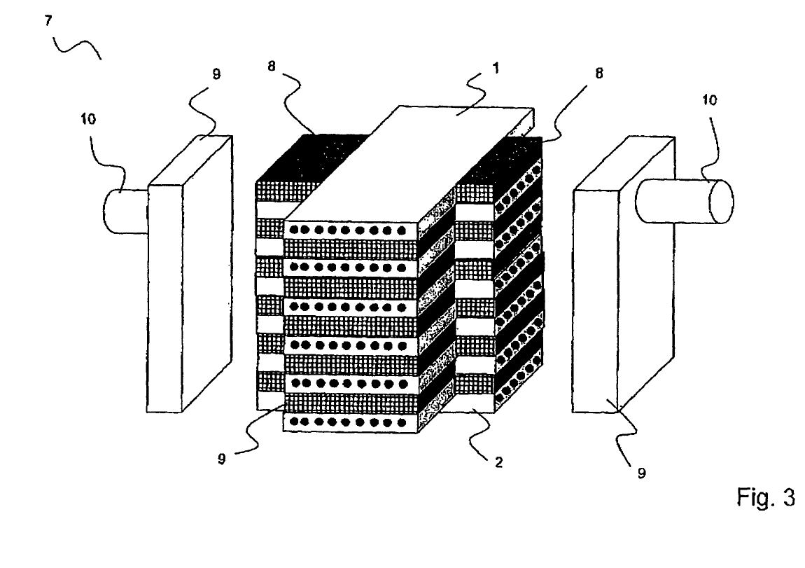

FIG. 3 shows a perspective view of a fuel cell module having parallel-connected anode and cathode plates, which are stacked one on top of the other in a cruciform manner, and having connecting stubs on the end faces of the fuel cell module for the gas and fuel supply; and

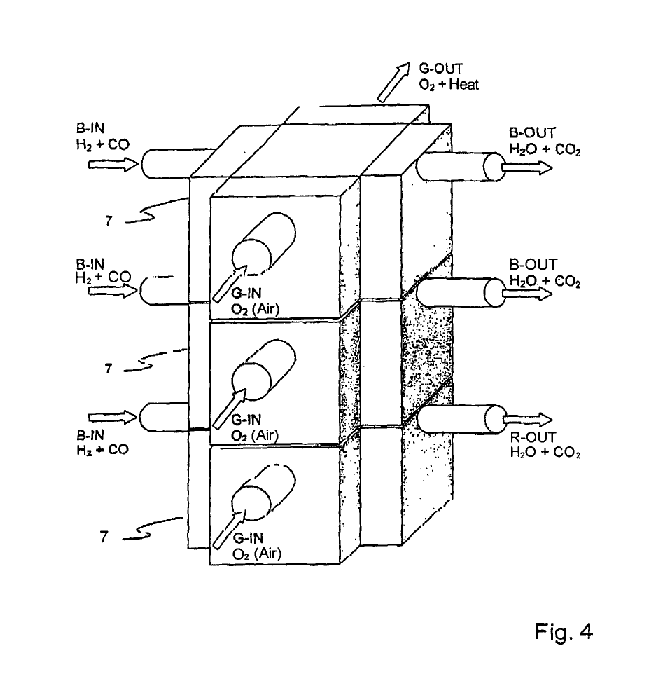

FIG. 4 shows a perspective view of a fuel cell having a large number of series-connected fuel cell modules stacked one on top of the other.

FIG. 1 shows a perspective view of the layer structure of an individual cell as a basic unit of a fuel cell module, which is essentially formed from an anode plate 1 and cathode plate 2, which are formed in layers one on top of the other in a cruciform manner, with electrolyte material 3 arranged between them.

One intermediate layer 4 is in each case provided on the surface between the electrolyte material 3 and the anode plate 1 or cathode plate 2. The intermediate layers 4 reduce the contact resistances between the electrolyte material 3 and the anode plate 1 or cathode plate 2, increase the permeability and provide a “weak point” in the thermal gradient, so that the anode and cathode plates 1, 2 remain unaffected in the event of different expansion resulting from thermal loads.

In a known manner, the anode and cathode plates 1, 2 have integrated tubes 5, which run parallel, for gas G or fuel B to pass through. The anode plates 1 may, for example, be burnt from Ni 8YSZ cermet and the cathode plates 2 may be burnt from perovskite (LaSrCaMnO3). By way of example, the intermediate layer 4 may be in the form of a mixed cathode composed of 8YSZ perovskite or ScSZ perovskite. 8 YSR or ScSZ is suitable for the electrolyte material 3. The materials mentioned are adequately known from fuel cell technology.

The effective conductivity σ_{K} of the cathode can be increased and can be made to balance the conductivity σ_{A} of the anode plate 1 by means of a metallic conductive grating 6 on the upper face of the upper cathode plate 2 and on the lower face of the lower cathode plate 2. By way of example, steels containing chromium may be used as the conductive gratings 6, so-called interconnectors.

The problem is that the performance of an individual cell is governed and limited predominantly by the low electron conductivity of a purely ceramic cathode composed of LSM. The current flow through the electrolyte material 4 and through a cathode plate 2 can be expressed as follows with the aid of the specific conductivities σ:
for the electrolyte material: I_{E}=U_{E}/R_{E}=(σ_{E}×A_{E}/d_{E})×U_{E}
for the cathode plate: I_{K}=U_{K}/R_{K}=(σ_{K}×A_{K}/d_{K})×U_{K}
with the variables
I=current,
U=voltage drop,
R=electrical resistance,
σ=specific electrical conductivity,
A=electrically conductive cross-sectional area, and
d=path length of the electrical resistance.

Since the two currents I_{E} through the electrolyte material 4 and I_{K} through the cathode plate 2 must be identical, this results, after solution of the above equations, for the electrically effective area of the cathode plate 2 in:
A_{K}=(σ_{E}/σ_{K})×(d_{K}/d_{E})×(U_{E}/U_{K})×A_{E}.

If the cathode plate 2 were to be produced only from LSM (for example perovskite), this would result, with corresponding values for typical conductivities at 1000° C. in:
σ_{E}=σ_{YSZ}≈20 S/m
σ_{K}=σ_{LSM}≈20*10³ S/m
and the geometric data of the individual cell:
d_{E}=100 μm
d_{K}≈10 cm
and a typical ratio of:
U_{E}/U_{K}≈1 . . . 10
in a value of:
A_{LSM}=(20 S/m/20*10³ S/m)×(10*10⁻⁴ m/10²*10⁻⁶ m)×(U_{E}/U_{K})×A_{YSZ}
A_{LSM}=(10⁻³⁻¹⁺²×(U_{E}/U_{K})×A_{YSZ}
A_{LSM}/A_{YSZ}≈1 . . . 10.

The conductive cross section of a cathode plate 2 composed of LSM should thus be approximately ten times greater than the conductive cross section of the electrolyte material 4 in order to make it possible to pass the same current I through it. It would thus be necessary either to increase the cross section A_{K} of the cathode plate 2 or its specific conductivity C_{K} by several orders of magnitude. Since it is not possible just to increase the cross section of the cathode plate 2, the effective conductivity σ_{K,eff} of the cathode plate 2 must be increased, and must be made to balance the conductivity of the anode plate 1. Steels with a high chromium content can be used as the metallic conductive gratings 6 for this purpose. Steels such as these have values of σ_{K}=2*10⁶ S/m at 1000° C. This means that the relative term in the equation mentioned above
A_{K}=(σ_{E}/σ_{K})×(d_{K}/d_{E})×(U_{E}/U_{K})×A_{E}
reaches acceptable orders of magnitude:
A_{K}=10⁻⁵⁻¹⁺⁴×(U_{E}/U_{K})×A_{YSZ}
A_{LSM}/A_{YSZ}≈10⁻¹ . . . 10⁻².

This means that, for a typical electrolyte area of about 100 cm², the metallic conductive grating 6 will have to assume a cross-sectional area of about 1 to 10 cm².

FIG. 2 shows one embodiment of a fuel cell module having a large number of anode and cathode plates 1, 2 which are stacked in a cruciform manner with an electrolyte material layer 3 located between them. In the exemplary embodiment, two cathode plates 2 are in each case arranged one on top of the other with an intermediate layer which does not conduct electrons, in order to match the conductivity.

As can be seen from FIGS. 1 and 2, the anode plates 1 are arranged with their longitudinal axis at an angle rotated through about 90° with respect to the longitudinal axis of the cathode plates 2, so that, seen in the clockwise direction, there is in each case an offset of 90° with respect to one another between the end faces of the anode plates 1 and the supply connections to the tubes 5, the end faces of the cathode plates 2 and the supply connections to the tubes 5, the end faces of the anode plates 1 to the outlet connections to the tubes 5 and the end faces of the cathode plates 2 to the outlet connections to the tubes 5. It is thus possible to provide in each case one single connecting stub for the gas supply, the gas outlet, the fuel supply and the fuel outlet on each end face of the fuel cell module. Furthermore, the anode plates 1 can be connected electrically in parallel, and the cathode plate 2 can likewise be connected in parallel with one another.

The low output DC voltage from the fuel cell module which results from this with a high current level in comparison to the conventional series connection can be compensated for by means of a power electronics circuit with power semiconductors.

FIG. 3 shows a perspective exploded view of a fuel cell module 7, in which a large number (preferably about 7 in each case) of anode plates 1 and cathode plates 2 are stacked one on top of the other in a cruciform manner. The electrolyte and intermediate layers 3, 4 are not shown. This clearly shows that electrically conductive filling material 8 is introduced into the spaces between the connecting ends of the anode and cathode plates 1, 2, which are stacked one on top of the other, such that the spaces are completely filled. A material which corresponds to the anode or cathode plates 1, 2, a metallic foam or a metallic felt may be used as the filling material.

The cruciform architecture of the fuel cell module means that the anode plates 1 and cathode plates 2 can be supplied in a compact uniform manner, and can each be electrically connected in parallel by connecting stubs 9, for example in the form of metallic bushes (ferritic steels). In this case, the gases and fuels for the anode plates 1 and cathode plates 2 are supplied and carried away separately by means of supply and exhaust-air lines 10. This is necessary as a function of the system in the case of fuel cells. The connecting stubs of the anode plates 1 are not illustrated, for the sake of clarity, but correspond to the sketched connecting stubs 9 for the cathode plates 2. The connecting stubs 9 should be corrosion-resistant, although the product water is removed continuously in the anode plates 1 at the high temperatures that occur during operation.

It is advantageous for air cooling to be used for removal of the product water. In this case, it would also be possible to use the condensation energy.

FIG. 4 shows a perspective view of a fuel cell with a large number of series-connected fuel cell modules 7 stacked one on top of the other. As can be seen, the supply B-IN of fuel, for example of H₂CO, methane or methanol or the like, is provided by the supply line 10 of the connecting stub 9 of the anode plates 1. After the reaction, that is to say H₂O+CO₂+heat, the fuel is carried away at the opposite end face of the anode plates 1. The air (O₂) is supplied by the supply line 10 of the connecting stub 9 of the cathode plates 2, and the depleted air O₂ and heat are carried away at the opposite end face of the cathode plates 2.

This allows a simple gas supply of air to the fuel cell modules 7 from one end face, and of fuel from the other end face, which is offset through 90° with respect to the other, with only two different paths, and with the air and product gas being carried away in a corresponding manner. This results in a considerable reduction in the problems relating to gas leaks, as a result of the reduction in the number of connections, since there is no longer any need to supply each anode and cathode plate 1, 2 individually. Furthermore, the fuel cell modules 7 in the fuel cell can be accommodated in a housing such that permanent external flushing around the connecting stubs 9 not only allows cooling—energy management—but also means that slight leaks, which are dependent on the operating phase, from the connecting stubs 9 are tolerable.

The electrical power can be tapped off via the metallic connecting stubs 9, for example by means of pressure contacts. In this case, the voltage is about 0.7 to 1 volt per fuel cell module with the individual cells connected in parallel. The current is about 50 amperes per fuel cell module. Connection of a large number of fuel modules 7 in series in a fuel cell allows the voltage to be increased to about 10 volts without having to accept significant structural problems relating to assembly, servicing and operational reliability/safety. Since the parallel connection in the fuel cell modules 7 means that complete failure is highly improbable, connection of the fuel cell modules 7 in series nevertheless ensures relatively stable operation.

1. A fuel cell module, comprising:
a number of permeable anode and cathode plates which are stacked one on top of the other;
electrolyte material between adjacent anode and cathode plates;
connections to the anode and cathode plates for supplying and carrying away gas (G) and fuel (B),
wherein the anode plates are connected electrically in parallel and the cathode plates are connected electrically in parallel,
wherein the anode plates and the cathode plates each have parallel tubes which extend in a longitudinal direction for gas (G) or fuel (B) to pass through,
wherein longitudinal axes of the anode plates are aligned offset at an angle to longitudinal axes of the cathode plates, and
wherein metallic connecting stubs are arranged on end faces of the anode plates and cathode plates and each communicate with the parallel tubes for supplying or carrying away gas (G) or fuel, with those anode plates or cathode plates which are in each case located on a common end face being connected electrically in parallel to the connecting stubs, and being connected to a common supply line or outlet line.

2. The fuel cell module as claimed in claim 1, wherein the anode and cathode plates have a rectangular base area with longitudinal faces which are longer than the end faces, with the anode plates being aligned parallel to one another and the cathode plates being aligned parallel to one another, and with the longitudinal axes of the anode plates being aligned offset at an angle to the longitudinal axes of the cathode plates.

3. The fuel cell module as claimed in claim 2, wherein the anode and cathode plates are arranged centered in a cruciform shape, with the longitudinal axes of the anode plates being aligned at right angles to the longitudinal axes of the cathode plates.

4. The fuel cell module as claimed in claim 1 further comprising an electrically conductive filling material filling in spaces at end faces connecting ends of the anode or cathode plates.

5. The fuel cell module as claimed in claim 4, wherein the common supply line or outlet line has a connecting stub which extends over the height of the fuel cell module and over a width of an associated end face.

6. The fuel cell module as claimed in claim 1 wherein the anode plates and the cathode plates have an electrically insulating, ion-conducting electrolyte layer on surfaces of a rectangular base area.

7. The fuel cell module as claimed in claim 6, wherein the electrolyte layer has 8YSR or ScSZ.

8. The fuel cell module as claimed in claim 1 further comprising an electrically insulating, ion-conducting intermediate layer between anode plates and cathode plates.

9. The fuel cell module as claimed in claim 8, wherein the intermediate layer has nickel-8YSR or CeOx/Ni.

10. The fuel cell module as claimed in claim 1 wherein the anode plates have nickel cermet.

11. The fuel cell module as claimed in claim 1 wherein the cathode plates have perovskite (LaxSryCazMnO3).

12. The fuel cell module as claimed in claim 1 further comprising a power electronics circuit with a current/voltage converter for increasing the voltage.

13. A fuel cell battery, comprising:
at least two fuel cell modules electrically connected in series wherein each of said fuel cell modules includes
a number of permeable anode and cathode plates which are stacked one on top of the other;
electrolyte material between adjacent anode and cathode plates;
connections to the anode and cathode plates for supplying and carrying away gas (G) and fuel (B),
wherein the anode plates are connected electrically in parallel and the cathode plates are connected electrically in parallel,
wherein the anode plates and cathode plates each have parallel tubes which extend in a longitudinal direction for gas (G) or fuel (B) to pass through,
wherein longitudinal axes of the anode plates are aligned offset at an angle to longitudinal axes of the cathode plates, and
wherein metallic connecting stubs are arranged on end faces of the anode plates and cathode plates and each communicate with the parallel tubes for supplying or carrying away gas (G) or fuel, with those anode plates or cathode plates which are in each case located on a common end face being connected electrically in parallel to the connecting stubs, and being connected to a common supply line or outlet line.

14. The fuel cell battery as claimed in claim 13, wherein the fuel cell modules are stacked one on top of the other.
